(19) United States
(12) Patent Application Publication
(10) Pub. No.: US 2021/0248317 A1
(43) Pub. Date: Aug. 12, 2021

(54) Method for enhanced text search indexing

(71) Applicant: Luminoso Technologies, Inc., Boston, MA (US)

(72) Inventors: William Wood Harter, JR., Aliso Viejo, CA (US); Bryan Kaanta, Surrey Hills (AU)

(21) Appl. No.: 17/172,876

(22) Filed: Feb. 10, 2021

Related U.S. Application Data
(60) Provisional application No. 62/975,002, filed on Feb. 11, 2020.

(51) Int. Cl. G06F 40/284; G06K 9/00; G06F 40/247; G06F 40/242; G06F 16/951; G06F 16/9532

(52) U.S. Cl. CPC G06F 40/284; G06K 9/00483; G06F 16/9532; G06F 40/242; G06F 16/951; G06F 40/247

(57) ABSTRACT

A system and related methods are disclosed for search enhancement of a text document. The index enhancing method includes identifying primary concepts and related concepts. The primary concepts include exact match concepts identified from the single primary document and the conceptual match concepts to the identified exact match concepts. The related concepts include exact match concepts identified from the related documents and conceptual match concepts to the identified exact match concepts. In some instances, the query can also be expanded using the same concepts identified for index enhancing.

### CROSS-REFERENCE TO RELATED APPLICATIONS

This application claims the benefit of U.S. provisional patent application No. 62/975,002 filed on Feb. 11, 2020, the content of which is incorporated herein by reference in its entirety.

### TECHNICAL FIELD

Embodiments of the present invention relate generally to natural language processing computer methods and systems, and more particularly to the text searching within documents.

### BACKGROUND ART

The designers of textual search algorithms face one of the more daunting tasks in computer engineering: creating algorithms that combine the speed of computer processing with the ability to mimic the human ability to perceive patterns in written language. The difficulty of this task is in the immense complexity of the latter part: to perfectly imitate human beings' facility with language is widely thought to be equivalent to perfectly imitating human intelligence. Search algorithms currently can only hope to approximate this feat well enough for the purposes of some limited range of tasks chosen by their designers. As any user of a modern search engine can attest, those approximations can produce some powerful results when searching large bodies of text for phrases of words, but always fall short of perfection.

Traditional search engines focus on the full-text indexing of natural language documents. The purpose of indexing a text document is to optimize speed and performance in finding relevant documents for a search query. However, the process of indexing knowledge bases, particularly in technical or complex domains, is incredibly difficult. Standard search indexing techniques, including building keywords using standard tokenization, are only able to use the knowledge contained in the searchable documents, and in some cases, additional hand-curated synonym tables.

### SUMMARY OF THE EMBODIMENTS

It is therefore a goal of the instant invention to provide efficient and effective search enhancement, which is robust even with small datasets, and is easy to embed with only small changes to existing workflow.

An index enhancing method is disclosed for searching text documents. The method includes (i) identifying primary concepts and (ii) identifying related concepts. The primary concepts include a) exact match concepts identified from the single “Primary” document and b) the conceptual match concepts to the identified exact match concepts, which allow for the conceptual expansion of the exact match concepts found in the Primary document. The related concepts include a) exact match concepts identified from the “Related” documents and b) conceptual match concepts to the identified exact match concepts, which allow for the conceptual expansion of the exact match concepts found in the Related documents.

Another method is disclosed herein for enhancing search results, where the query can also be expanded using the same concepts identified for index enhancing as described above.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a schematic diagram illustrating a conventional index workflow, in which text is first extracted from a document by means of a Tika extractor, web crawler, database lookup, or other suitable means and then packaged into JavaScript Object Notation (JSON) and passed to a search engine for indexing; wherein the most common analyzer is standard tokenization, which breaks text by whitespace and punctuation to create a list of items.

FIG. 2 is a schematic diagram illustrating a workflow in accordance with the disclosed method, which includes creating a project around Primary (searchable) documents and Related documents such as reviews, chat logs, and help desk tickets, for example.

FIG. 3 is a more detailed workflow diagram illustrating the disclosed method, wherein related concepts are added based on QuickLearn™ performing transfer learning on the dataset and the ConceptNet background space.

FIG. 4 is a schematic diagram illustrating the Search Enhancement model in accordance with the disclosed method.

FIG. 5 illustrates an example data format in accordance with the disclosed method.

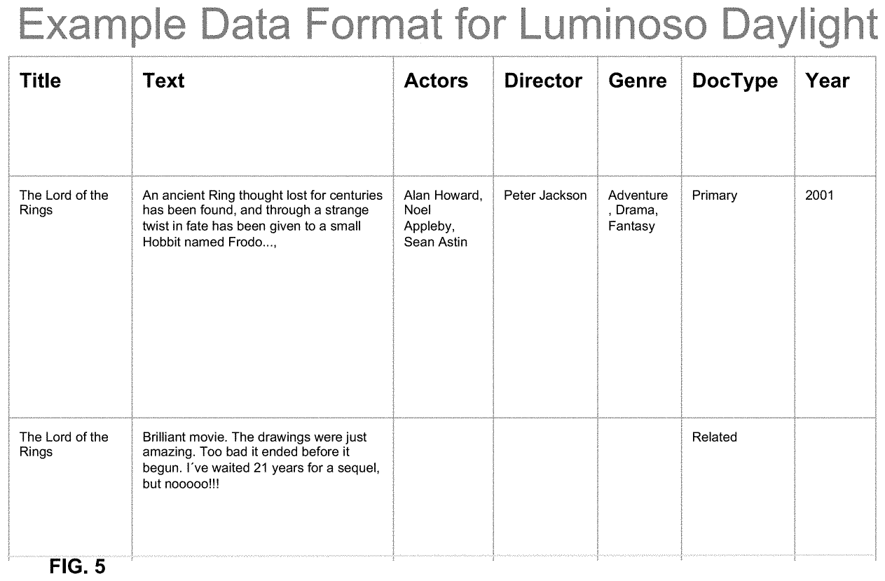

FIG. 6 is an illustration of a limited conventional indexing method by means of standard tokenization, wherein whitespace and punctuation are used to build an index using document text. A standard analyzer built into the index service is used to find the search terms; however, in this search result, only one movie was included while missing other highly relevant movie results.

FIG. 7 illustrates a conventional index search method, which can only conduct a search using the original text that was tokenized using conventional analysis.

FIG. 8 is a schematic diagram of the disclosed method, illustrating a Primary document concept expansion from domain knowledge, wherein the extended terms are added to the index when simply analyzing the Primary document, wherein the dataset contains many Related documents.

FIG. 9 is an illustration of the term expansion approach in accordance with the disclosed method, wherein the terms from related documents such as movie reviews are added to the pool of terms to be indexed.

FIG. 10 is an example of expanded search in accordance with the disclosed method, wherein the search incorporates both the plot summary expansion and the expansion around the related review documents.

FIG. 11 is a further illustration of the expanded search approach shown in accordance with the disclosed method as illustrated in FIG. 10.

FIG. 12 is a schematic diagram illustrating another approach of the disclosed method, which utilizes a query expansion approach.

FIG. 13 illustrates an expanded index search using query expansion in accordance with the disclosed method as schematically shown in FIG. 12.

FIG. 14 is a schematic diagram of the kind of electronic device that performs the disclosed method and comprises the disclosed system.

FIG. 15 is a schematic diagram illustrating the disclosed system and depicting a typical web application deployment.

### DETAILED DESCRIPTION OF SPECIFIC EMBODIMENTS

The disclosed invention is a method performed by a computer or similar electronic device, which uses term or keyword searching to find the best match in a set of documents. The disclosed methods use term expansion techniques as well as query expansion techniques resulting in efficient and effective search enhancement, such that end users will benefit from the improved accuracy of the searches, without noticing a decrease in performance.

### Definitions

As used in this description and the accompanying claims, the following terms shall have the meanings indicated, unless the context otherwise requires:

An “electronic device” is defined herein as including personal computers, laptops, tablets, smart phones, and any other electronic device capable of supporting an application as claimed herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smartphone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” is a general term for all equipment coupled to an electronic device that may be used to enter data into that device. This definition includes, without limitation, keyboards, computer mouses, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “manual data entry means” is the set of all data entry devices coupled to the electronic device that permit the user to enter data into the electronic device using manual manipulation. This definition includes, without limitation, keyboards, keypads, touchscreens, track-pads, computer mouses, buttons, and other similar components.

An electronic device's “display means” is a device coupled to the electronic device, by means of which the electronic device can display images. This definition includes, without limitation, monitors, screens, television devices, and projectors.

To “maintain” data in the memory of an electronic device means to store that data in any memory coupled to the electronic device in a form convenient for retrieval as required by the algorithm at issue, and to retrieve, update, or delete the data as needed.

A “term” is any string of symbols that may be represented as text on or by an electronic device as defined herein. In addition to single words made of letters in the conventional sense, the meaning of “term” as used herein includes, without limitation, a phrase made of such words, a sequence of nucleotides described by AGTC notation, any string of numerical digits, and any string of symbols whether their meanings are known or unknown to any person.

A “document” may be any collections of terms, as defined above, including books, articles, papers, web pages, and other collections of words in the colloquial sense, the nucleotide sequences of organisms, chromosomes, or plasmids, the amino acid sequences representing proteins, any subsection of any of the preceding examples, and any samples of text or textually representable patterns containing the textual data patterns the user wishes to investigate.

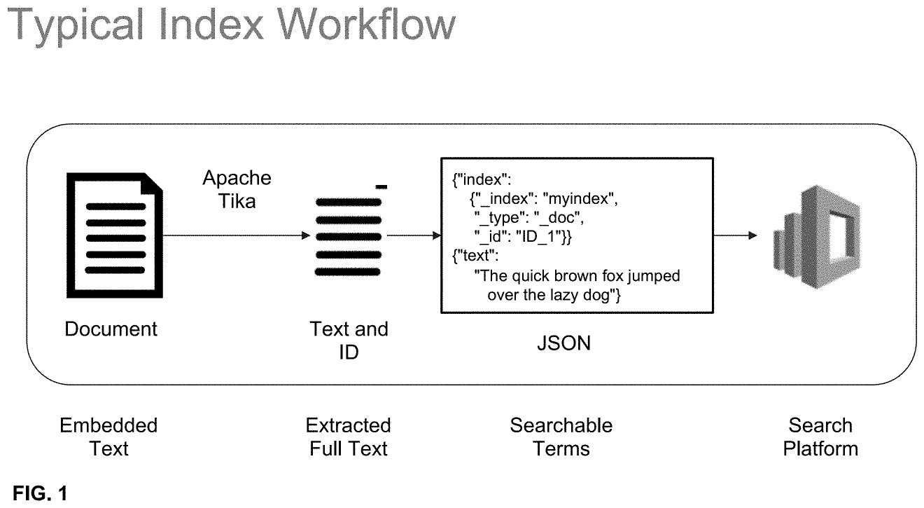

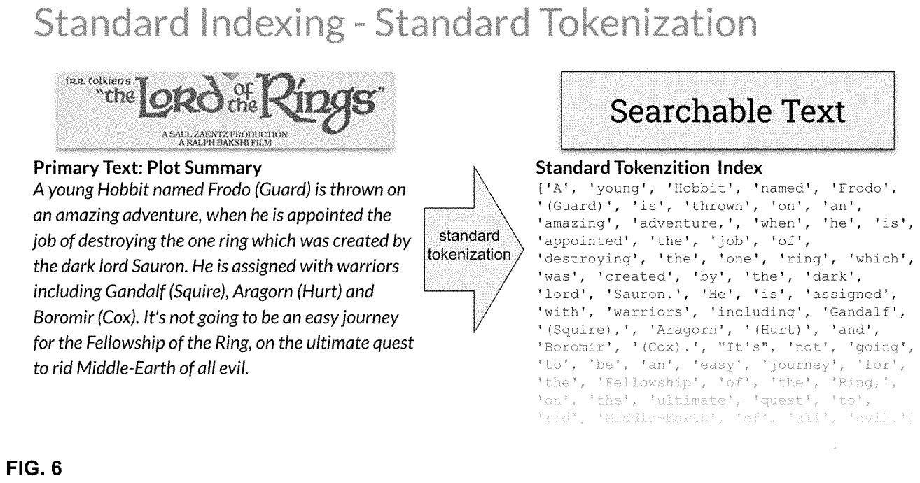

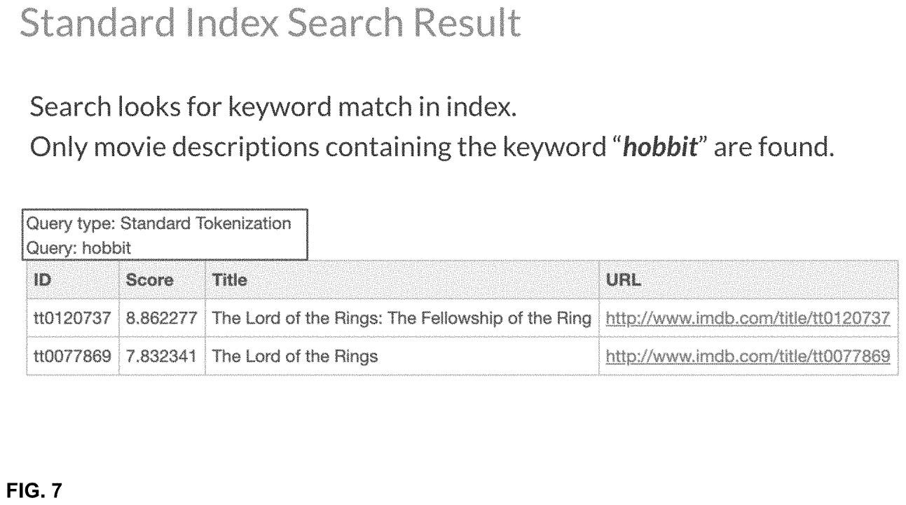

As illustrated in FIG. 1, in a conventional index workflow, text is first extracted from a document using a Tika extractor, web crawler, database lookup, or other suitable means. It is then packaged into JSON and passed to a search engine for indexing. The standard analyzer is performing standard tokenization, which breaks the text by whitespace and punctuation to create a list of terms. However, this standard indexing technique is not perfect and characterized by a limited dataset as further illustrated by FIGS. 6-7, where the standard analyzers built into the index service is used to find the search terms. However, in this dataset, only one result is included and the dataset is missing other results, which could have been surfaced based on similarities drawn by people leaving reviews. The dataset is lacking this additional information because the standard index search is configured to search only the original text on the document that has been analyzed with standard tokenization.

Building a search index can be greatly enhanced using the disclosed methods by leveraging an internal parser and using the resulting terms and fragments identified in each document uploaded in the disclosed system. The parser of the disclosed system has some novel features not available in any standard parsers. It is configured to identify collocations (i.e., multi-word concepts or phrases), which can enhance search results. It is also configured to identify related concepts not in the Primary document, but are highly related to concepts within the language space as measured by the unique vector model.

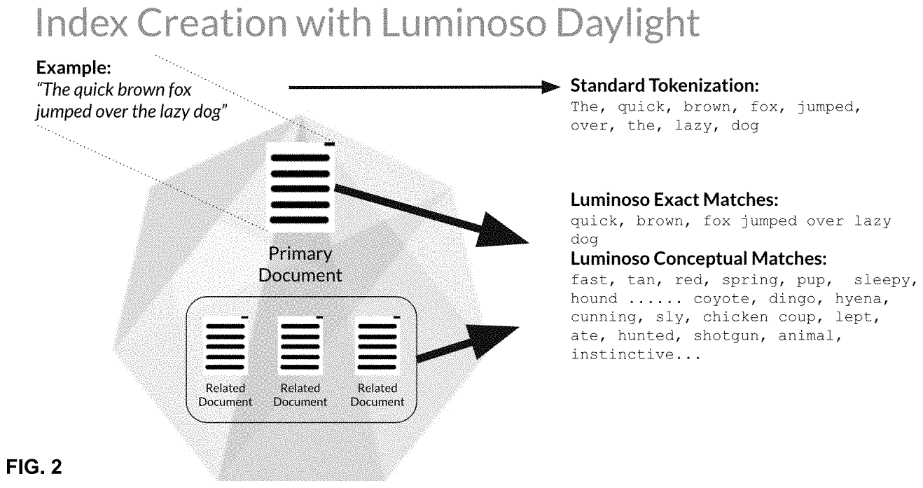

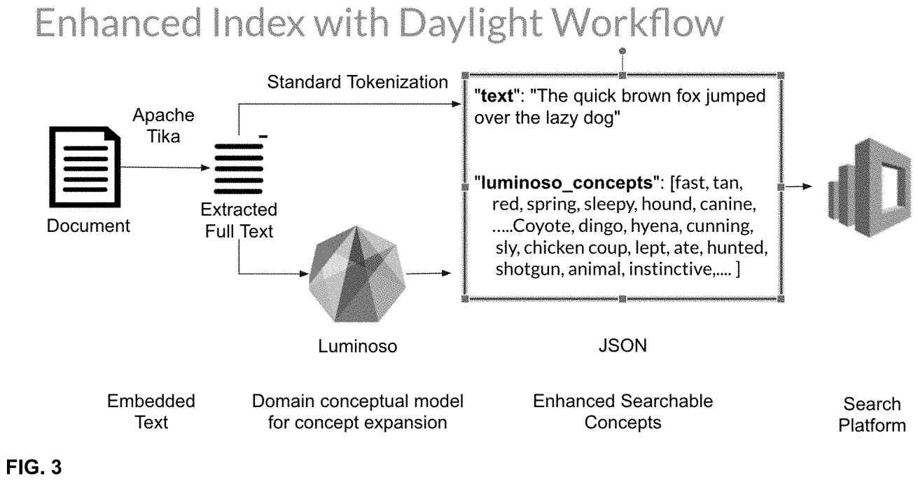

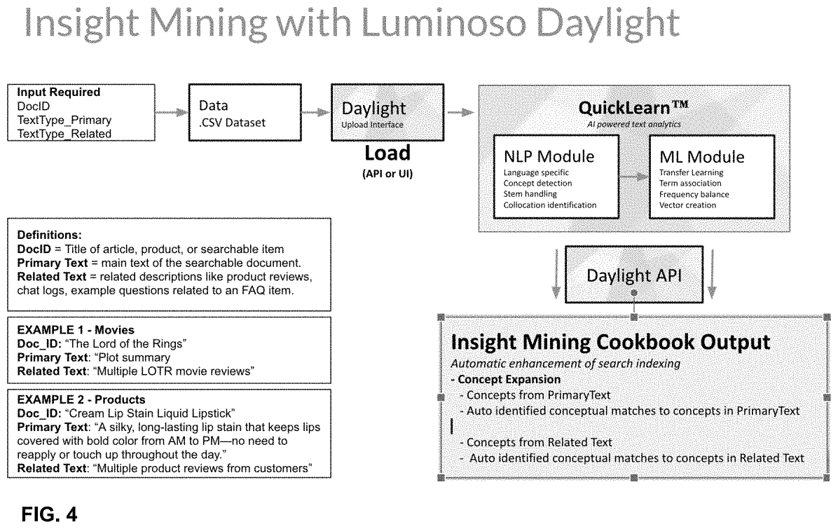

According to the disclosed method, there could be two types of documents that can be used to enhance the search index. As illustrated in FIG. 2, the first document type is a Primary document that is intended to be the core text description of a searchable ID. The second is a Related document, used to inform the domain space and enhance the conceptual search details of the searchable ID beyond or outside of the core text of the Primary documents. For example, in a search of a movie database, each movie will have a document that is the plot summary and include details about the movie, actors, and situation. This is the Primary document. The unique ID would be the name of the movie. Movie reviews or other plot summaries are the Related documents and are used to build up broader related concepts that describe the movie in alternative ways to the Primary document. Thus, the disclosed method creates a project around the Primary (searchable) documents and the Related documents (such as reviews, chat logs, help desk tickets, etc.), and the disclosed system is configured to automatically find related concepts based on the documents in the project pool. As shown in FIGS. 3-4, the text is passed to the disclosed system before creating the JSON and the list of concepts, terms and fragments is packaged with the text. In this example, the disclosed system can add related concepts based on the background space. Terms like “tan”, “spring”, “hound”, and a collocation “quickly jump” are all possible related concepts. The larger the background space, the better the conceptual match list will be.

The disclosed method includes (i) identifying primary concepts and (ii) identifying related concepts. The primary concepts include a) exact match concepts identified from the single “Primary” document and b) the conceptual match concepts to the identified exact match concepts, which allow for the conceptual expansion of the exact match concepts found in the Primary document. The related concepts include a) exact match concepts identified from the “Related” documents and b) conceptual match concepts to the identified exact match concepts, which allow for the conceptual expansion of the exact match concepts found in the Related documents.

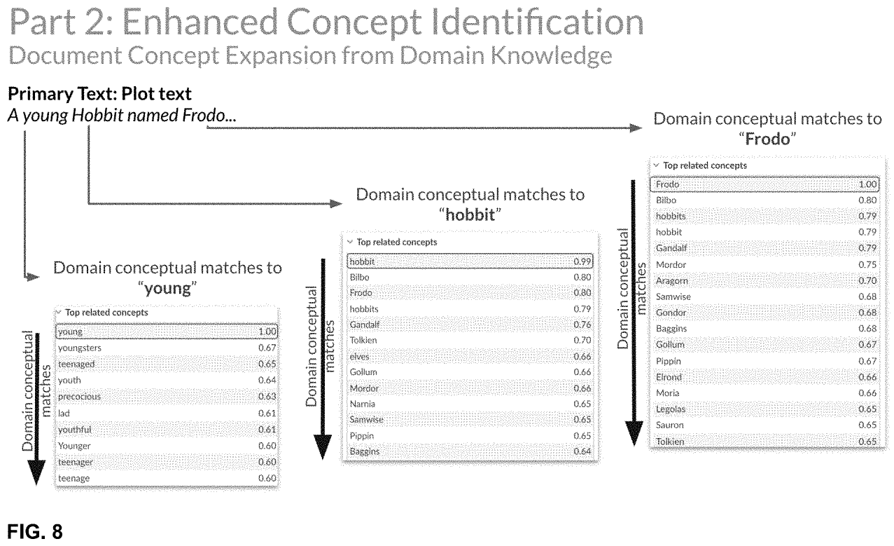

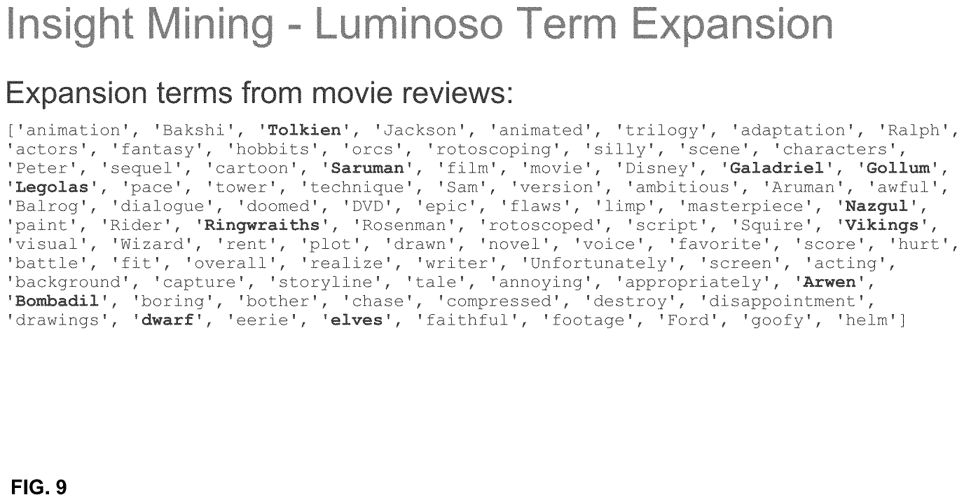

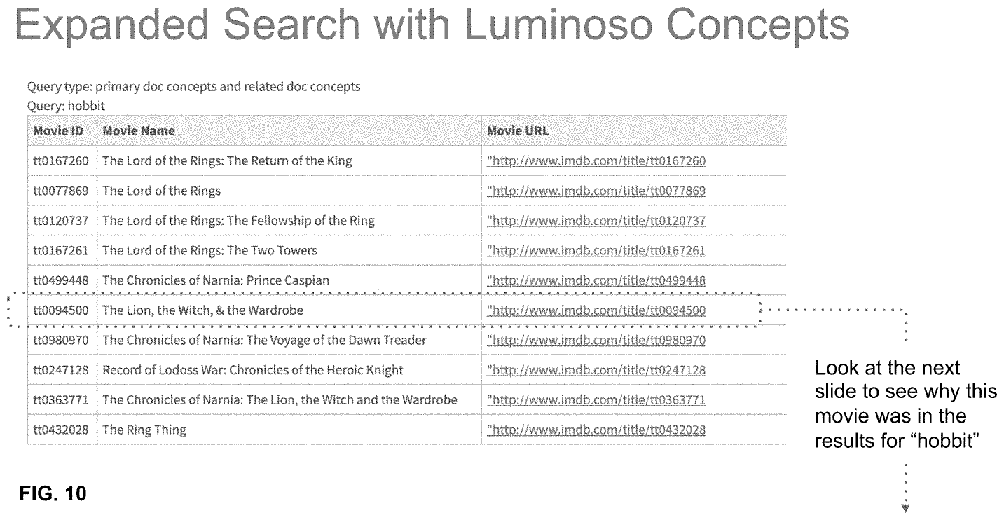

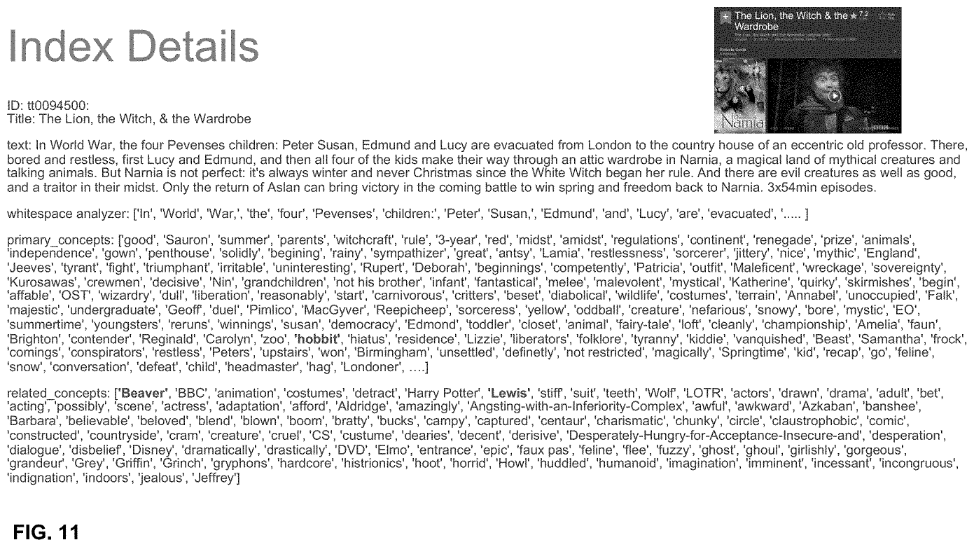

The disclosed method of term expansion is better understood in reference to FIGS. 8-11, which show the enhancement process of a Primary document expanded from domain knowledge. The plot summary (the Primary document) is analyzed, and additional concepts are identified through simultaneous analysis of movie reviews (the Related documents); these extended terms are added to the index as illustrated in FIG. 8. Related documents could uncover additional concepts not present in the Primary documents. For example, as shown in FIG. 9, the disclosed method discovered additional terms “Tolkien,” “Saruman,” “Galadriel,” etc. from reviews, where the term “Bombadil” is particularly illustrative, as it references a character in the book who did not appear in the movies. The level of complementary detail added by related concepts is also shown in FIGS. 10-11, where the plot summary is the Primary document containing the term “hobbit” and the reviews are the Related documents including the terms “Beaver” and “Lewis. The former references a talking beaver in The Chronicles of Narnia series, and the latter references Tolkien's dear friend and author of the Narnia series, C. S. Lewis. Tolkien and Lewis' fantasy worlds are often discussed in concert with one another. Thus, the search enhancement provided on “hobbit” returns additional fantasy movie results which would not have been discovered if searching against the Primary document alone.

The method is further illustrated by the following examples. The elements in the disclosed method are the “search_doc_id” (aka the movie title, product name, or FAQ reference number). Each “search_doc_id” can have two document types stored in a metadata field called “search_doc_type”. This metadata field identifies the document as either the “primary” text description or a “related” text description. The “primary” text description will be analyzed to populate “primary_concepts”. The “related” text description (there can be many “related” text descriptions associated with a single “search_doc_id”) will inform a list of “related_concepts”.

### Example 1. “Dune”

```
search_doc_id = “Dune”
search_do_type = “primary”.
  The plot summary would be the Primary document. It provides the basis for the
  primary_concepts with the search_doc_id = “Dune”.
search_doc_type = “related”.
```

The movie reviews would be the group of Related documents. They are used to enhance the concepts associated with the search_doc_id=“Dune,” and can be weighted in a different way to primary_concepts for the purpose of the search.

### Some Example Primary and Secondary Documents for “Dune”

{search_doc_id: “dune”,
search_doc_type: “primary”
text: “Dune is a movie about a futuristic desert planet called Arrakis or Dune where spice is
mined. Spice is the main component required for space travel.”
}
{search doc id: “dune”,
Search_doc_type: “related”,
text: “I really didn't like how the Baron Harkonen was portrayed. He wasn't like that in the
book and the padashar emperor wasn't far behind”
}
{search doc id: “dune”,
search_doc_type: “related”,
text: “There was just so much sand and no water anywhere. Could the Bene Gesserit witch have
been any more dumb or the sand worms been any larger”
}

These documents are loaded into the disclosed system along with a dataset of other movie descriptions and reviews. These are used to build a contextual understanding of how people talk about the Dune movie. This domain-specific knowledge is used to populate the following search index enhancements.

### Example 2. “Airline FAQ”

Primary Text

“Can I still use the return flight of my roundtrip booking if I missed the departure flight? If for any reason you miss the first sector of a return flight, your return sector is still valid. No refund will be given for the first sector. Not applicable to Korea flights.”

Standard Analyzer:

[‘Can’, ‘I’, ‘still’, ‘use’, ‘the’, ‘return’, ‘flight’, ‘of’, ‘my’, ‘roundtrip’, ‘booking’, ‘if’, ‘I’, ‘missed’, ‘the’, ‘departure’, ‘flight?’, ‘If’, ‘for’, ‘any’, ‘reason’, ‘you’, ‘miss’, ‘the’, ‘first’, ‘sector’, ‘of’, ‘a’, ‘return’, ‘flight’, ‘your’, ‘return’, ‘sector’, ‘is’, ‘still’, ‘valid.’, ‘No’, ‘refund’, ‘be’, ‘given’, ‘for’, ‘the’, ‘first’, ‘sector.Not’, ‘applicable’, ‘to’, ‘Korea’, ‘flights’]

Primary and Related Concepts:

[‘China’, ‘claim missing’, ‘select’, ‘Taiwan’, ‘20 Aug. 2019’, ‘scheduled departure time’, ‘claim’, ‘higher’, ‘previous’, ‘korea’, ‘low’, ‘price’, ‘provide’, ‘button’, ‘Passengers traveling’, ‘difference’, ‘not allowed to do online check-in’, ‘call’, ‘allowed’, ‘U-Biz’, ‘utilize’, ‘required’, ‘reasons’, ‘hotline number’, ‘call the hotline’, ‘Thailand’, ‘discounts’, ‘transaction’, ‘not received’, ‘baby passengers’, ‘Manage My Booking’, ‘months from the date’, ‘Mobile Application’, ‘schedule’, ‘Ufly-Pass Priority Tickets will be valid’, ‘Saipan’, ‘make a booking’, ‘cancel’, ‘1 hour’, ‘relevant’, ‘not applicable’, ‘period’, ‘special assistance’, ‘Fare difference applies’, ‘pre-boarding’, ‘Manage My Booking” portal’, ‘date’, ‘fails’, ‘not be refunded’, ‘not’, ‘Vietnam and Cambodia’, ‘select the flight’, ‘Hong Kong SAR’, ‘prior’, ‘related’, ‘time’, ‘cancel flights’, ‘voucher’, ‘latest’, ‘departing’, ‘not allowed’, ‘leave’, ‘wish’, ‘HK Express’ base fares are non-refundable’, ‘click “Search”’, ‘Japan’, ‘not apply’, ‘original fare’, ‘get a refund’, ‘least 48 hours’, ‘Hong Kong International Airport Departure’, ‘not available for bookings with infants’, ‘validity’, ‘hours in advance’, ‘points’, ‘take’, ‘contact our call center hotline’, ‘missing reward-U points’]

### Example 3. “The Matrix Reloaded”

Primary Text:

“Six months after the events depicted in The Matrix, Neo has proved to be a good omen for the free humans, as more and more humans are being freed from the matrix and brought to Zion, the one and only stronghold of the Resistance. Neo himself has discovered his superpowers including super speed, ability to see the codes of the things inside the matrix, and a certain degree of precognition. But a nasty piece of news hits the human resistance: 250,000 machine sentinels are digging to Zion and would reach them in 72 hours. As Zion prepares for the ultimate war, Neo, Morpheus and Trinity are advised by the Oracle to find the Keymaker who would help them reach the Source. Meanwhile Neo's recurrent dreams depicting Trinity's death have got him worried and as if it was not enough, Agent Smith has somehow escaped deletion, has become more powerful than before and has chosen Neo as his next target.”

Standard Analyzer:

[‘Six’, ‘months’, ‘after’, ‘the’, ‘events’, ‘depicted’, ‘in’, ‘The’, ‘Matrix,’, ‘Neo’, ‘has’, ‘proved’, ‘to’, ‘be’, ‘a’, ‘good’, ‘omen’, ‘for’, ‘the’, ‘free’, ‘humans,’, ‘as’, ‘more’, ‘and’, ‘more’, ‘humans’, ‘are’, ‘being’, ‘freed’, ‘from’, ‘the’, ‘matrix’, ‘and’, ‘brought’, ‘to’, ‘Zion,’, ‘the’, ‘one’, ‘and’, ‘only’, ‘stronghold’, ‘of’, ‘the’, ‘Resistance.’, ‘Neo’, ‘himself’, ‘has’, ‘discovered’, ‘his’, ‘superpowers’, ‘including’, ‘super’, ‘speed,’, ‘ability’, ‘to’, ‘see’, ‘the’, ‘codes’, ‘of’, ‘the’, ‘things’, ‘inside’, ‘the’, ‘matrix,’, ‘and’, ‘a’, ‘certain’, ‘degree’, ‘of’, ‘precognition.’, ‘But’, ‘a’, ‘nasty’, ‘piece’, ‘of’, ‘news’, ‘hits’, ‘the’, ‘human’, ‘resistance:’, ‘250,000’, ‘machine’, ‘sentinels’, ‘are’, ‘digging’, ‘to’, ‘Zion’, ‘and’, ‘would’, ‘reach’, ‘them’, ‘in’, ‘72’, ‘hours.’, ‘As’, ‘Zion’, ‘prepares’, ‘for’, ‘the’, ‘ultimate’, ‘war,’, ‘Neo,’, ‘Morpheus’, ‘and’, ‘Trinity’, ‘are’, ‘advised’, ‘by’, ‘the’, ‘Oracle’, ‘to’, ‘find’, ‘the’, ‘Keymaker’, ‘who’, ‘would’, ‘help’, ‘them’, ‘reach’, ‘the’, ‘Source.’, ‘Meanwhile’, “Neo's”, ‘recurrent’, ‘dreams’, ‘depicting’, “Trinity's”, ‘death’, ‘have’, ‘got’, ‘him’, ‘worried’, ‘and’, ‘as’, ‘if’, ‘it’, ‘was’, ‘not’, ‘enough,’, ‘Agent’, ‘Smith’, ‘has’, ‘somehow’, ‘escaped’, ‘deletion,’, ‘has’, ‘become’, ‘more’, ‘powerful’, ‘than’, ‘before’, ‘and’, ‘has’, ‘chosen’, ‘Neo’, ‘as’, ‘his’, ‘next’, ‘target.’]

Related Text 1 of 13:

“As soon as I began to see posters and hear talk about this movie, I was immediately excited. The Matrix was an incredible to behold and I couldn't wait to see the second one, especially after beginning to see the trailers for it at other movies. However, when I saw it, I left the theater extremely disappointed, as did many other movie-goers at the theater with me. While the action scenes in the movie were amazing as always, there simply were too few of them. In the first movie, there was constant fighting going on it seemed, but the second took a much more (and much unfortunate) preachy point of view. To sum up the plot, there wasn't much to it that wasn't expected. The machines were digging toward Zion with intent of destroying it (that's not a spoiler, everyone saw it in the commercials). The dialogue of the movie was absolutely horrendous. Unless you're a psychology major, you most likely will not understand most of what is said in the movie, and because of that simply won't care. It became somewhat of a romantic movie with the showing of events happening in the lives and relationship of Neo and Trinity. Agent Smith, for as bad-ass as he was in the first movie, seemed to get all religious and preachy. Personally, I don't need to hear about that or pay money to listen to it. The movie was a serious waste of my time, and I don't think I can watch the first one anymore. The dialogue and the constant boring and dry monologues from basically every character made me lose interest in the film quickly, and the small amount of good fighting scenes pushed me nearer the edge, and the ending of the movie shoved me right off. What movie ends with “To Be Concluded”? How original is that folks. I wonder if the Wachowski brothers had to burn the midnight oil to come up with that one. In conclusion, the movie was bad and that's the end of it.”

Primary Concepts:

[‘located’, ‘reptilian’, ‘portrayed’, ‘CIA’, ‘tropes’, ‘Alta’, ‘decimated’, ‘Smith’, ‘less’, ‘irrefutable’, ‘November’, ‘helpings’, ‘humanity’, ‘intermission’, ‘DEA’, ‘reborn’, ‘reporter’, ‘achieve’, ‘nice’, ‘mythos’, ‘Angkor’, ‘prophetic’, ‘alterations’, ‘September’, ‘mph’, ‘unpleasant’, ‘definitely’, ‘Matrix’, ‘specified’, ‘comparatively’, ‘speed’, ‘discover’, ‘embodies’, ‘Antichrist’, ‘smarter’, ‘minutes’, ‘competence’, ‘nullified’, ‘insurgency’, ‘Krimi’, ‘mechs’, ‘successive’, ‘dreamer’, ‘concerned’, ‘news’, ‘much’, ‘characterized’, ‘synagogue’, ‘graphically’, ‘satisfactory’, ‘Armageddon’, ‘substantially’, ‘choose’, ‘advice’, ‘nasty’, ‘neo’, ‘dreamland’, ‘founded’, ‘qualifications’, ‘apprehensive’, ‘recommend’, ‘“mumblecore”’, ‘continual’, ‘overrun’, ‘Wirth’, ‘Oracle’, ‘superpower’, ‘Sentry’, ‘upcoming’, ‘action-oriented’, ‘WWI’, ‘recommendation’, ‘Adventists’, ‘agency’, ‘theology’, ‘mankind’, ‘cyclical’, ‘events’, ‘choice’, ‘prove’, ‘Bullseye’, ‘resurrection’, ‘lookout’, ‘months’, ‘report’, ‘Kor’, ‘opposition’, ‘Xena’, ‘eventual’, ‘wary’, ‘resistance’, ‘slightly’, ‘intermittent’, ‘snag’, ‘vile’, ‘bother’, ‘gateway’, ‘Dex’, ‘assistance’, ‘min’, ‘Neo’, ‘next’, ‘Vinci’, ‘machine’, ‘occurrences’, ‘oracle’, ‘not invited’, ‘sentinel’, ‘prepare’, ‘Wilcox’, ‘battlefield’, ‘untimely’, ‘A.I.’, ‘worried’, ‘Slipstream’, ‘christians’, ‘uber’, ‘eludes’, ‘mechanical’, ‘specific’, ‘regime’, ‘strong’, ‘theological’, ‘fortnight’, ‘stronghold’, ‘superheroes’, ‘opted’, ‘month’, ‘happenings’, ‘reassure’, ‘periodic’, ‘target’, ‘Terminator’, ‘powerfully’, ‘recurrent’, ‘tabloid’, ‘substantiates’, ‘repugnant’, ‘Necroborgs’, ‘capabilities’, ‘no responsible’, ‘FBI’, ‘superhuman’, ‘great’, ‘source’, ‘reenactment’, ‘prophesied’, ‘depicted’, ‘humanoid’, ‘evade’, ‘newscast’, ‘humankind’, ‘corroborated’, ‘democracy’, ‘teleportation’, ‘typewriter’, ‘coincidental’, ‘mega’, ‘counseling’, ‘electrocution’, ‘millenium’, ‘incident’, ‘reflexion’, ‘factions’, ‘escape’, ‘years’, ‘Sanders’, ‘help’, ‘Citadel’, ‘apparatus’, ‘reach’, ‘depiction’, ‘Robocop’, ‘demonstrates’, ‘Brainiac’, ‘accelerated’, ‘find’, ‘infinitely’, ‘automatons’, ‘quickness’, ‘coverage’, ‘decisive’, ‘Viet’, ‘Stanton’, ‘certain’, ‘divinity’, ‘Howell’, “‘Rosebud’”, ‘rawness’, ‘hour’, ‘mins’, ‘tyranny’, ‘depict’, ‘terrific’, ‘icky’, ‘sanctuary’, ‘mutation’, ‘annihilation’, ‘outpost’, ‘excellent’, ‘harbinger’, ‘obliterated’, ‘zion’, ‘suppression’, ‘MOH’, ‘machinery’, ‘death’, ‘broadcaster’, ‘Code’, ‘Sith’, ‘aptitude’, ‘fantasizes’, ‘ability’, ‘Presbyterian’, ‘Nin’, ‘superpowers’, ‘deathbed’, ‘captivity’, ‘option’, ‘repulsive’, ‘L.L.’, ‘powerful’, ‘represents’, ‘Civil’, ‘outrun’, ‘Exorcist’, ‘culmination’, ‘hrs’, ‘Shiloh’, ‘decent’, ‘proves’, “o'clock”, ‘code’, ‘resonant’, ‘distasteful’, ‘reverie’, ‘validates’, ‘smash’, ‘skills’, ‘discovers’, ‘peeved’, ‘including’, ‘Morpheus’, ‘curtailed’, ‘trinity’, ‘bodes’, ‘precognition’, ‘unearthed’, ‘formidable’, ‘dieing’, ‘flee’, ‘daydream’, ‘deletion’, ‘WWII’, ‘TBS’, ‘operative’, ‘week’, ‘wrathful’, ‘become’, ‘pictorial’, ‘after’, ‘discovery’, ‘exemplifies’, ‘suggest’, ‘get’, ‘IRS’, ‘Boyd’, ‘deity’, ‘watchtower’, ‘irrespective’, ‘deleted’, ‘fatalities’, ‘IBM’, ‘Vietnam’, ‘lite’, ‘ready’, ‘hit’, ‘bring’, ‘guarded’, ‘matrix’, ‘premonition’, ‘bulwark’, ‘film-goers’, ‘thermonuclear’, ‘Incubus’, ‘potent’, ‘disprove’, ‘watchman’, ‘calamitous’, ‘human’, ‘demise’, ‘vicious’, ‘beings’, ‘G-d’, ‘unveils’, ‘consulted’, ‘assist’, ‘forthcoming’, ‘keymaker’, ‘more’, ‘approximately’, ‘ascended’, ‘bastion’, ‘reconsider’, ‘prepared’, ‘domination’, ‘certainty’, ‘suicide’, ‘nightmare’, ‘advent’, ‘okay’, ‘upset’, ‘Racer’, ‘heed’, ‘illustrate’, ‘defiance’, ‘strength’, ‘fascists’, ‘motif’, ‘Webb’, ‘Thompson’, ‘well-lit’, ‘newspaper’, ‘recurring’, ‘delves’, ‘printer’, ‘aid’, ‘include’, ‘attain’, ‘piece’, ‘super’, ‘un-noticed’, ‘final’, ‘anxious’, ‘Jerusalem’, ‘inadvertent’, ‘humane’, ‘preparation’, ‘Horns’, ‘worry’, ‘capacity’, ‘queries’, ‘dream’, ‘revealed’, ‘rapid’, ‘inside out’, ‘Lugia’, ‘Wellspring’, ‘Jenkins’, ‘cataclysmic’, ‘dig’, ‘not excellent’, ‘January’, ‘war’, ‘ultra’, ‘half’, ‘ultimate’, ‘exodus’, ‘mastery’, ‘considerably’, ‘invulnerable’, ‘fortress’, ‘February’, ‘Methodist’, ‘fast’, ‘discloses’, ‘eventful’, ‘agent’, ‘bulletin’, ‘aimed’, ‘Realtor’, ‘Sentinel’, ‘yucky’, ‘Interpol’, ‘smith’, ‘increasingly’, ‘search’, ‘die’, ‘free’, ‘super-hero’, ‘omen’, ‘encoded’, ‘automatic’, ‘Jabez’, ‘doctrine’, ‘degree’, ‘notified’, ‘filthy’, ‘clock’, ‘getaway’, ‘selected’, ‘Keymaker’, ‘innate’, ‘morpheus’, ‘buried’, ‘fretting’, ‘contraption’, ‘Iraq’, ‘uncover’, ‘proof’, ‘advise’, ‘rediscovered’, ‘nor implied’, ‘unprepared’, ‘Mordor’, ‘jailbreak’, ‘excavating’, ‘submachine’, ‘warfare’, ‘Zion’, ‘see’, ‘prowess’, ‘Trinity’, ‘CNN’, ‘rebirth’, ‘Omen’, ‘WW2’, ‘broker’, ‘Webber’, ‘good’, ‘fortified’, ‘December’, ‘findings’, ‘momentous’, ‘overwritten’, ‘OST’, ‘event’, ‘Azar’, ‘BG’, ‘mammals’]

Related Concepts:

[‘Matrix’, ‘Neo’, ‘Reloaded’, ‘sequence’, ‘plot’, ‘scene’, ‘dialogue’, ‘disappointed’, ‘Morpheus’, ‘sequel’, ‘Trinity’, ‘Zion’, ‘agent’, ‘actors’, ‘SPOILERS’, ‘Wachowski’, ‘boring’, ‘bunch’, ‘basically’, ‘movie’, ‘chase’, ‘disappointment’, ‘fake’, ‘Keanu’, ‘martial arts’, ‘philosophical’, ‘theater’, ‘trailer’, ‘aspect’, ‘Smith’, ‘fight’, ‘drawn’, ‘special effects’, ‘characters’, ‘accent’, ‘architect’, ‘argue’, ‘assume’, ‘blown’, ‘bullet-time’, ‘commentary’, ‘discovers’, ‘excuse’, ‘expectations’, ‘explore’, ‘Fishburne’, ‘fortune’, ‘franchise’, ‘gradually’, ‘handled’, ‘harm’, ‘Hugo’, ‘inconsistencies’, ‘jarring’, ‘Midnight’, ‘monologue’, ‘Moss’, ‘movie-goers’, ‘not believable’, ‘Oracle’, ‘pathetic’, ‘philosophizing’, ‘pointless’, ‘poorly’, ‘posing’, ‘preachy’, ‘predecessor’, ‘rave’, ‘Reeves’, ‘sais’, ‘science fiction’, ‘SciFi’, ‘script’, ‘shoved’, ‘skip’, ‘Smiths’, ‘stunt’, ‘sucks’, ‘suffering’, ‘sum’, ‘sword’, ‘twist’, ‘utterly’, ‘utter’, ‘viewer’, ‘no plot’, ‘film’, ‘push’, ‘revolution’, ‘incredible’, ‘exciting’, ‘thrown’, ‘watch’, ‘wonder’, ‘worse’, ‘realize’, ‘dance’, ‘fails’, ‘Unfortunately’, ‘dream’]

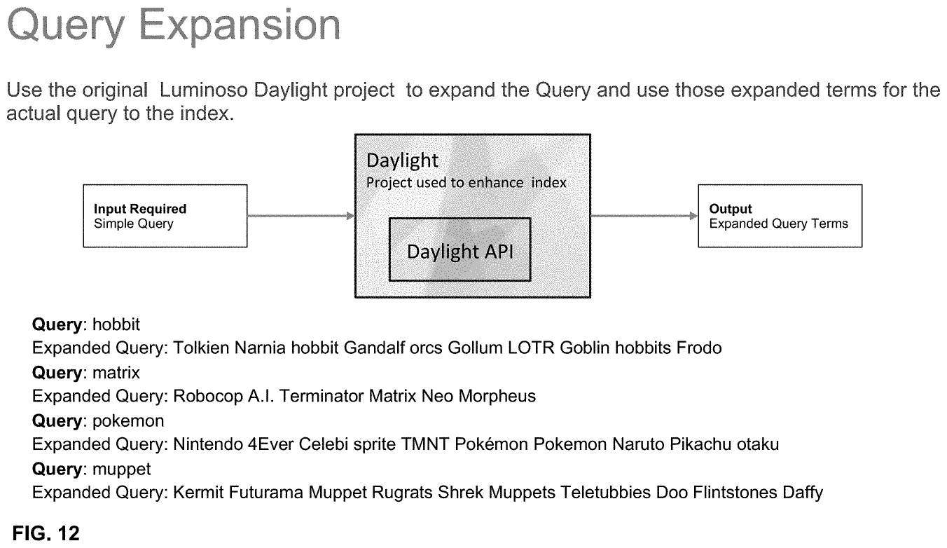

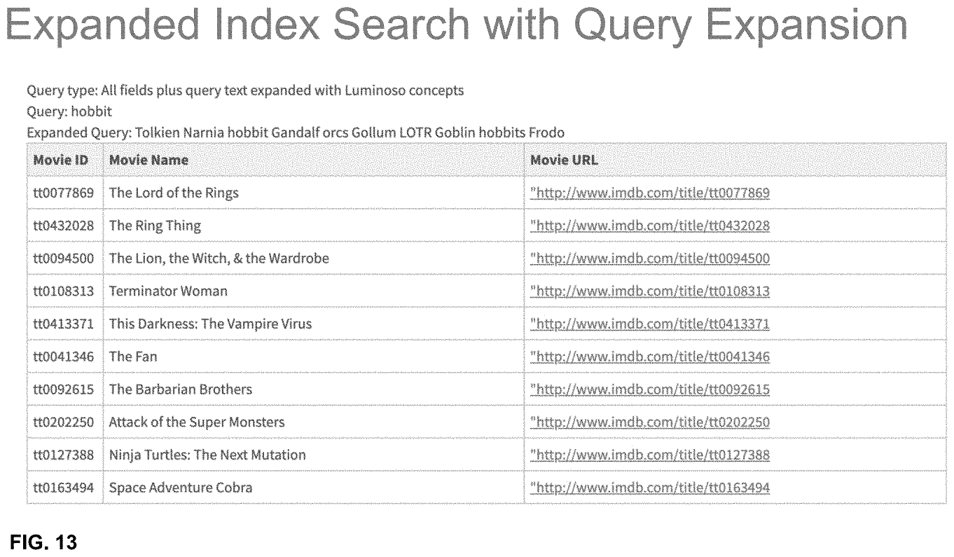

According to another method of the present disclosure, as illustrated in FIGS. 12-13, a query can also be expanded using the concepts from the index enhancement as described above. For instance, using movie examples, the following queries were expanded into a new query using Luminoso Daylight.

Query: hobbit

Expanded Query: Tolkien Narnia hobbit Gandalf ores Gollum LOTR Goblin hobbits Frodo

Query: matrix

Expanded Query: Robocop A.I. Terminator Matrix Neo Morpheus

Query: pokemon

Expanded Query: Nintendo 4Ever Celebi sprite TMNT Pokémon Pokemon Naruto Pikachu otaku

Query: muppet

Expanded Query: Kermit Futurama Muppet Rugrats Shrek Muppets Teletubbies Doo Flintstones Daffy

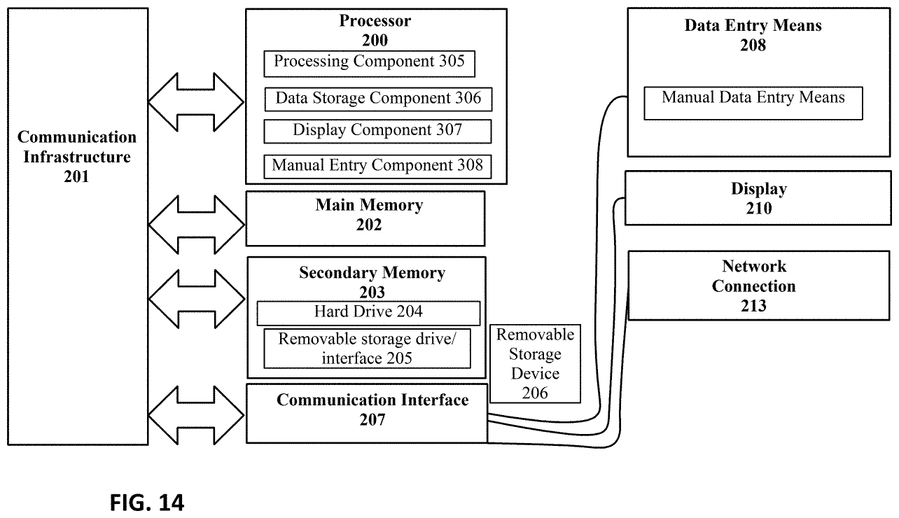

Also, the system and method disclosed herein will be better understood in light of the following observations concerning the electronic devices that support the disclosed application, and concerning the nature of applications in general. An exemplary electronic device is illustrated by FIG. 14. The processor 200 may be a special purpose or a general-purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, which can include such manual entry means 209 as keyboards, touchscreens, mouses, and trackpads, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

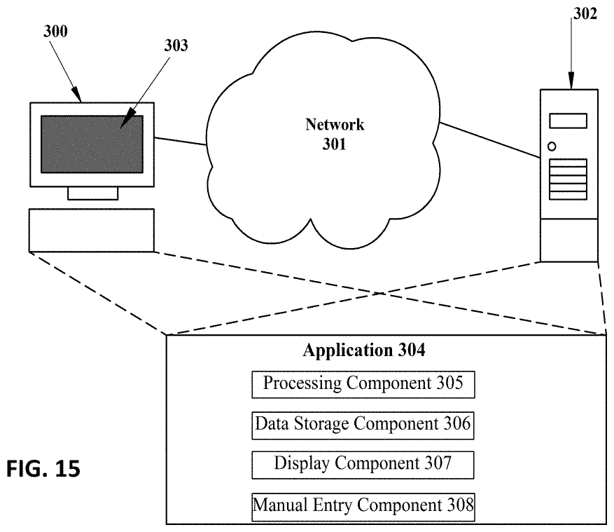

This invention could be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 15. Web application platforms typically include at least one client device 300, which is an electronic device as described above. The client device 300 connects via some form of network connection to a network 301, such as the Internet. Also connected to the network 301 is at least one server device 302, which is also an electronic device as described above. Of course, practitioners of ordinary skill in the relevant art will recognize that a web application can, and typically does, run on several server devices 302 and a vast and continuously changing population of client devices 300. Computer programs on both the client device 300 and the server device 302 configure both devices to perform the functions required of the web application 304. Web applications 304 can be designed so that the bulk of their processing tasks are accomplished by the server device 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server device 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications require some computer program configuration both of the client device (or devices) 300 and the server device 302 (or devices). The computer program that comprises the web application component on either electronic device's system FIG. 14 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. A method for building enhanced search indexing of text documents, the method comprising:
providing a primary text document and one or more related documents;
extracting a text from the documents by an extractor;
performing standard tokenization by breaking the text by whitespace and punctuation to create a list of terms;
performing a conceptual expansion by creating enhanced searchable concepts;
packaging the list of terms and the enhanced searchable concepts into JSON; and
passing the JSON package to a search engine for indexing.

2. A method according to claim 1, wherein the extractor is a Tika extractor, web crawler, database lookup, or combination thereof.

3. A method according to claim 1, wherein performing a conceptual expansion by creating enhance searchable concepts comprising:
(a) identifying primary concepts and (b) identifying related concepts.

4. A method according to claim 3, wherein the primary concepts include exact match concepts identified from the primary text document and the conceptual match concepts to the identified exact match concepts, thereby allowing for the conceptual expansion of the exact match concepts found in the primary document.

5. A method according to claim 3, wherein the related concepts include exact match concepts identified from the related documents and conceptual match concepts to the identified exact match concepts, thereby allowing for the conceptual expansion of the exact match concepts found in the related documents.

6. A method according to claim 1, wherein the primary text document is a query.

7. A system for enhanced search indexing of text documents, the system comprising:
one or more processors; and
one or more memories having stored thereon instructions that, when executed by the one or more processors, cause the one or more processors to:
extract a text from a primary document and one or more related documents;
perform standard tokenization by breaking the text by whitespace and punctuation to create a list of terms;
perform a conceptual expansion by creating enhanced searchable concepts;
package the list of terms and the enhanced searchable concepts into JSON; and
pass the JSON package to a search engine for indexing.

8. A system according to claim 7, wherein performing a conceptual expansion by creating enhance searchable concepts comprising:
(a) identifying primary concepts and (b) identifying related concepts.

9. A system according to claim 8, wherein the primary concepts include exact match concepts identified from the primary text document and the conceptual match concepts to the identified exact match concepts, thereby allowing for the conceptual expansion of the exact match concepts found in the primary document.

10. A system according to claim 8, wherein the related concepts include exact match concepts identified from the related documents and conceptual match concepts to the identified exact match concepts, thereby allowing for the conceptual expansion of the exact match concepts found in the related documents.

11. A system according to claim 7, wherein the primary text document is a query.

12. A non-transitory physical computer storage comprising computer-executable instructions that, when executed by one or more computing devices, configure the one or more computing devices to:
extract a text from a primary document and one or more related documents;
perform standard tokenization by breaking the text by whitespace and punctuation to create a list of terms;
perform a conceptual expansion by creating enhanced searchable concepts;
package the list of terms and the enhanced searchable concepts into JSON; and
pass the JSON package to a search engine for indexing.

13. A non-transitory physical computer storage according to claim 12, wherein performing a conceptual expansion by creating enhance searchable concepts comprising:
(a) identifying primary concepts and (b) identifying related concepts.

14. A non-transitory physical computer storage according to claim 13, wherein the primary concepts include exact match concepts identified from the primary text document and the conceptual match concepts to the identified exact match concepts, thereby allowing for the conceptual expansion of the exact match concepts found in the primary document.

15. A non-transitory physical computer storage according to claim 13, wherein the related concepts include exact match concepts identified from the related documents and conceptual match concepts to the identified exact match concepts, thereby allowing for the conceptual expansion of the exact match concepts found in the related documents.

16. A non-transitory physical computer storage according to claim 12, wherein the primary text document is a query.
